(19) United States
(12) Patent Application Publication
(10) Pub. No.: US 2026/0044673 A1
(43) Pub. Date: Feb. 12, 2026

(54) FINE-TUNING LANGUAGE MODELS FOR NETWORK DEVICES

(71) Applicant: Cisco Technology, Inc., San Jose, CA (US)

(72) Inventors: Robert Edgar Barton, Richmond (CA); Jerome Henry, Pittsboro, NC (US); Frank Brockners, Koln (DE); Bhavik Pradeep Shah, Bangalore (IN); Samer Salam, Beirut (LB)

(21) Appl. No.: 18/801,117

(22) Filed: Aug. 12, 2024

(51) Int. Cl. G06F 40/20; G06F 16/33

(52) U.S. Cl. CPC G06F 40/20; G06F 16/3347

(57) ABSTRACT

Techniques and mechanisms for fine-tuning a language model to be optimized for a network device to which the language model is deployed. A controller for a network may maintain an inventory of network devices in a network, and obtain device information for the network devices. The controller may analyze the device information to determine a device type or role for the network devices. The controller may then select a pre-trained model that is optimal or well-suited for a device type of a particular network device, and perform a distillation function of the language model. Once the language model has been distilled, the controller may augment the language model with locally relevant information such that the language model is contextually relevant for the network device. After fine-tuning the language model, the controller pre-positions the language model on the device so network administrators and other users can access it when necessary.

### TECHNICAL FIELD

The present disclosure relates generally to deploying language models to network devices to improve the ability of the network devices to interact with network administrators and engineers.

### BACKGROUND

Computer networks, or groups of connected computers or other devices that use communication protocols to exchange data, have continued to become more complex. The difficulties in managing these complex networks brought about the introduction of network controllers, such as those used in Software-Defined Networking (SDN). Network controllers play a pivotal role in network management by centralizing control over network devices and acting as a single point of management for configuring, monitoring, and optimizing network traffic flows across network infrastructure. Using communication protocols like OpenFlow, controllers communicate with network devices and instruct them on how to handle traffic based on policies and network conditions. Controllers abstract network control from physical hardware, enabling dynamic, programmable network management that adapts swiftly to changing demands. This centralized approach enhances scalability, agility, and operational efficiency, empowering administrators to enforce consistent network policies and security measures seamlessly across the entire network infrastructure.

Controllers have become well-adopted in the industry for centralized onboarding, configuration, and management of network elements. However, when network issues occur, the last line of defense may be at the individual device itself. During troubleshooting, an administrator will log into a device to run debugs, investigate logs, make network changes, and much more. Network administrators often use command line interfaces (CLIs) to troubleshoot devices issues, even when network controllers are in use.

However, CLI administration is clunky, inefficient, and generally slow unless the administrator has gained a mastery of the CLI over many years. For instance, network administrators generally have to know what specific CLI commands to use in order to troubleshoot devices and understand the results that are returned from the CLI commands, which are often difficult to understand. Accordingly, it can be difficult for network administrators to quickly and effectively interact with network devices using CLIs.

### BRIEF DESCRIPTION OF THE DRAWINGS

The detailed description is set forth below with reference to the accompanying figures. In the figures, the left-most digit(s) of a reference number identifies the figure in which the reference number first appears. The use of the same reference numbers in different figures indicates similar or identical items. The systems depicted in the accompanying figures are not to scale and components within the figures may be depicted not to scale with each other.

FIG. 1 illustrates a system-architecture diagram of an environment in which a controller performs techniques for fine-tuning a language model to be optimized for a network device to which the language model is deployed.

FIG. 2 illustrates a flow diagram of an example method for fine-tuning a language model to be optimized for a network device to which the language model is deployed.

FIG. 3 illustrates an example diagram of a network device that uses retrieval-augmented generation (RAG) to obtain embeddings from a vector database to provide a small language model (SLM) that responds to prompts from network administrators.

FIG. 4 illustrates a flow diagram of an example method for selecting a language model for a network device based on the language model being pre-trained for a device type of the network device.

FIG. 5 illustrates a flow diagram of an example method for distilling a language model to reduce the size of the language model for deployment to a network device.

FIG. 6 illustrates a flow diagram of an example method for augmenting a language model using locally relevant information for a network device such that the language model is contextually relevant for the network device.

FIG. 7 illustrates a flow diagram of an example method for a network device to receive a language model and respond to a prompt of a network administrator using the language model.

FIG. 8 is a computer architecture diagram showing an example computer architecture for a device capable of executing program components that can be utilized to implement aspects of the various technologies presented herein.

### DESCRIPTION OF EXAMPLE EMBODIMENTS

### Overview

The present disclosure relates generally to fine-tuning a language model to be optimized for a network device to which the language model is deployed. The language model is used by the network device to more effectively respond to prompts of network administrators.

A first method described herein includes selecting a language model for a network device based on the language model being pre-trained for a device type of the network device. The first method may include receiving, at a network controller, device information for the network device deployed in a network that is managed by the network controller. The first method may further include determining, using the device information, a device type of the network device in the network, and selecting the language model from a set of language models based at least in part on the language model being pre-trained for the device type. Additionally, the first method may include causing, by the controller, deployment of the language model to the network device.

A second method described herein includes distilling a language model to reduce the size of the language model for deployment to a network device. The second method may include receiving device information for a network device deployed in a network that is managed by a network controller, and obtaining a language model that is pre-trained with data associated with at least one of the network or the network device. Further, the second method may include distilling the language model to result in a distilled language model where the distilling comprises, using the device information, identifying a portion of the language model that is unrelated to functionality of the network device, and removing the portion of the language model. In such examples, the distilled language model requires less memory to store than the language model. The second method may further include causing deployment of the distilled language model to the network device.

A third method described herein includes augmenting a language model using locally relevant information for a network device such that the language model is contextually relevant for the network device. The third method may include receiving device information for a network device deployed in a network that is managed by a network controller, and obtaining a language model that is pre-trained with data associated with at least one of the network or the network device. Further, the third method may include augmenting the language model with locally relevant information specific to the network device such that the language model is contextually relevant for the network device, and causing deployment of the language model to the network device.

A fourth method described herein is for a network device to receive a language model and respond to a prompt of a network administrator using the language model. The fourth method may include providing, from a network device, device information to a network controller that manages a network in which a network device is located. The fourth method may further include receiving a small language model that is pre-trained with data associated with the network device, and receiving, via a communication interface, a prompt from a network administrator associated with the network device. Additionally, the fourth method may include determining, using the SLM, a response to the prompt received from the network administrator, and sending the response to the network administrator via the communications interface.

Additionally, the techniques of at least the first method, second method, third method, and the fourth method, and any other techniques described herein, may be performed by a system and/or device having non-transitory computer-readable media storing computer-executable instructions that, when executed by one or more processors, performs the method(s) described above.

### Example Embodiments

This disclosure describes techniques for fine-tuning a language model to be optimized for a network device to which the language model is deployed. A controller for a network may maintain an inventory of network devices in a network, and obtain device information for the network devices. The controller may analyze the device information to determine a device type or role for the network devices, as well as resource constraints of the devices, including memory constraints, central processing unit (CPU) resource constraints, and storage constraints of the network devices. The controller may then select a pre-trained model that is optimal or well-suited for a device type of a particular network device, and perform a distillation function of the language model. The distillation function may produce a fine-tuned distilled language model that is more refined for the network device. Once the language model has been distilled, the controller may augment the language model with locally relevant information such that the language model is contextually relevant for the network device. After fine-tuning the language model, the controller pre-positions the language model on the device so network administrators and other users can access it when necessary.

Network administrators connect to network devices and once authenticated, can use network device CLIs to issue prompts and commands. However, CLI administration is clunky, inefficient, and generally slow unless the administrator has gained a mastery of the CLI over many years. For instance, network administrators generally have to know what specific CLI commands to use in order to troubleshoot devices and understand the results that are returned from the CLI commands, which are often difficult to understand. Accordingly, it can be difficult for network administrators to quickly and effectively interact with network devices using CLIs.

There have been advances in artificial intelligence (AI) that have enabled chatbots and other AI systems to perform complex tasks that normally require human intelligence. Generative AI is a type of artificial intelligence where models are used to create (or “generate”) new content based on inputs, often in the form of prompts from users. One type of generative AI model is particularly effective at generating text, specifically, the large language model (LLM). LLMs are trained on large sets or corpuses of text data to perceive and infer context from user queries, understand a broader range of queries, and generate human-like textual responses to the queries. Chatbots that are backed by LLMs are becoming increasingly popular among users due to their ability to perform complex tasks on behalf of users.

LLMs may be utilized according to the techniques described herein to augment the CLI and assist network administrators (or “admins”) that are interacting with network devices, such as by interpreting debugs, investigating on-board logs, explaining configuration snippets, and even generating CLI commands on behalf of admins. However, LLMs generally require large amounts of computing resources to run, and often require specialized hardware (e.g., graphic processing units (GPUs) to efficiently run.

Network devices are often resource-constrained devices, such as switches, routers, or firewalls, which makes it very difficult or impossible to run an LLM locally on these devices. Even for inference applications, network devices do not have GPUs that are needed to accelerate token generation. In addition to being very large and resource intensive, the off-the-shelf open-source LLMs do not have contextually relevant fine-tuning to be useful on these network devices.

The techniques described herein include creating fine-tuned, small language model (SLMs) that are optimized for the roles or device types of the network devices to which they are deployed. In some examples, a network controller for the network of devices may obtain a catalogue or group of pre-trained language models, such as LLMs. Each of the pre-trained models may be trained for different types of networks (e.g., wide-area networks (WANs), data center networks, Internet of Things (IoT) networks, etc.), and/or for different types of devices (e.g., firewalls, switches, routers, etc.). Each pre-trained model may cover or be trained on the vocabulary (e.g., configuration, debugs, etc.) of each device type based on its capabilities and functionalities.

The controller may maintain an inventory or catalogue of the different network devices in the network, and may further obtain device information for the devices. For instance, the controller may use various commands to obtain comprehensive diagnostic reports from network devices (e.g., “show tech” command). The device information may include hardware information, software versions, configurations of the network devices (e.g., settings for interfaces, routing protocols, security features, etc.), system resources (e.g., utilization of CPU or memory, buffer pools, etc.), status information, routing and switching information logs and events, diagnostic and debugging information, and various types of telemetry data. The controller may examine the details for each network device and determine the device types or roles of the devices, the hardware model, the capabilities of the devices, the resource constraints of the devices (e.g., supports 10B parameters, maximum of 3.5 Gigabytes (GB) of memory, 20 tokens of processing speed, etc.), and what services or features the network device is using (e.g., Layer 2 (L2) or L3 security, Quality of Services (QoS) policies, overlay services, routing protocols, etc.).

After analyzing this various information for a network device, the controller may select a pre-trained model that is best suited for the type of device. For instance, the controller may select an LLM that is pre-trained for a firewall device if the controller is deploying the model to a firewall. However, the LLM that is selected may require more resources to run than that available or permitted by the network device. In such examples, the controller may perform a distillation function for the model to make a smaller, more refined model. For example, based on the device information for the network device, the controller may determine what services are in use.

For instance, a router may be using Open Shortest Parth First (OSPF) routing protocol, but it may not be configured to use other routing protocols, such as Intermediate System to Intermediate System (IS-IS) routing protocol, Enhanced Interior Gateway Routing Protocol (EIGRP), or Border Gateway Protocol (BGP). The controller may execute a model distillation process to reduce the size or number of parameters, while retaining much of the LLM's performance. For instance, the SLM that is generated for the router discussed above may be distilled to remove knowledge or parameters related to IS-IS, EIGRP, and BGP because the router is not configured to use those protocols. In some examples, depending on the resources of the network device, the controller may use model quantization techniques to alter the floating-point values used in tokenization to better suit resources of the networking device. In this way, the controller is able to create a fine-tuned, and distilled model for the network device.

Depending on the capabilities of the controller, the controller may perform the distillation function on its own (if it's loaded with GPUs), or it may use a cloud resource for this element of fine-tuning. Additionally, other model trimming techniques may be used to reduce the size of the LLMs, such as model pruning and removing the unused vocabulary (e.g., vocabulary on BGP that has a low probability of being associated to the OSPF vocabulary on a router that has OSPF configured, but not BGP).

After the model has been distilled or otherwise has had its size reduced, the controller may augment the SLM with locally relevant information. Specifically, the device information obtained for the device may be used to further fine-tune the model. For example, the controller may augment the SLM with new data, features, or functionalities determined using the device information. The SLM may be augmented with data related to new features of the network device, locally relevant state information, local configurations not represented in the SLM, and so forth.

Alternatively, retrieval-augmented generation (RAG), or a similar technique, could be used to make the SLM locally and contextually relevant for each device. For instance, the device information may be converted into embeddings using an embedding model, and the embeddings may be entered into a vector database stored locally on the network device. In some instances, rather than using an embedding model and vector database, the device information for a context window may be retrieved by querying local application programming interfaces (APIs) that return the locally relevant context information that may be provided to the SLMs.

With the SLM now fine-tuned, the controller may pre-position the SLM on the network device so network admins can access it if and when necessary. The SLM may be used as a type of chatbot that receives prompts from network admins on behalf of, or in conjunction with, the CLIs. In some examples, the SLMs may allow network admins to submit queries or prompts in natural languages, rather than using CLI commands. In some instances, the controller may occasionally refresh the distillation and/or fine tuning of the local SLM on the device in the cloud and replace the current model as new features are introduced. In this way, the techniques described herein result in the deployment of SLMs on network devices that are tuned to the computing capabilities, local context, and configurations of the network devices and potentially networks in which the devices are deployed.

While some of the techniques are described herein as being performed by a network controller, some or all of the techniques may be performed by other devices. For instance, a dedicated service may be created for the networks that performs the techniques, and/or a remote service may be employed, such as a cloud-based service, to perform some or all of the techniques. Further, while the techniques are described with respect to LLMs and SLMs, any type of models may be used. That is, the models may not necessarily comply with the definitions of LLMs and SLMs, but the general idea of distilling or reducing the size of the initial model into a smaller model (less memory required to store) is included in the techniques of this disclosure. That is, an LLM may simply be any model that is larger than the SLM that is placed on the network devices, but the models themselves may not necessarily comply with industry definitions of LLMs and SLMs. For instance, the models may both technically be SLMs, but the model deployed to the network device may simply be smaller than the initial model being considered.

Certain implementations and embodiments of the disclosure will now be described more fully below with reference to the accompanying figures, in which various aspects are shown. However, the various aspects may be implemented in many different forms and should not be construed as limited to the implementations set forth herein. The disclosure encompasses variations of the embodiments, as described herein. Like numbers refer to like elements throughout.

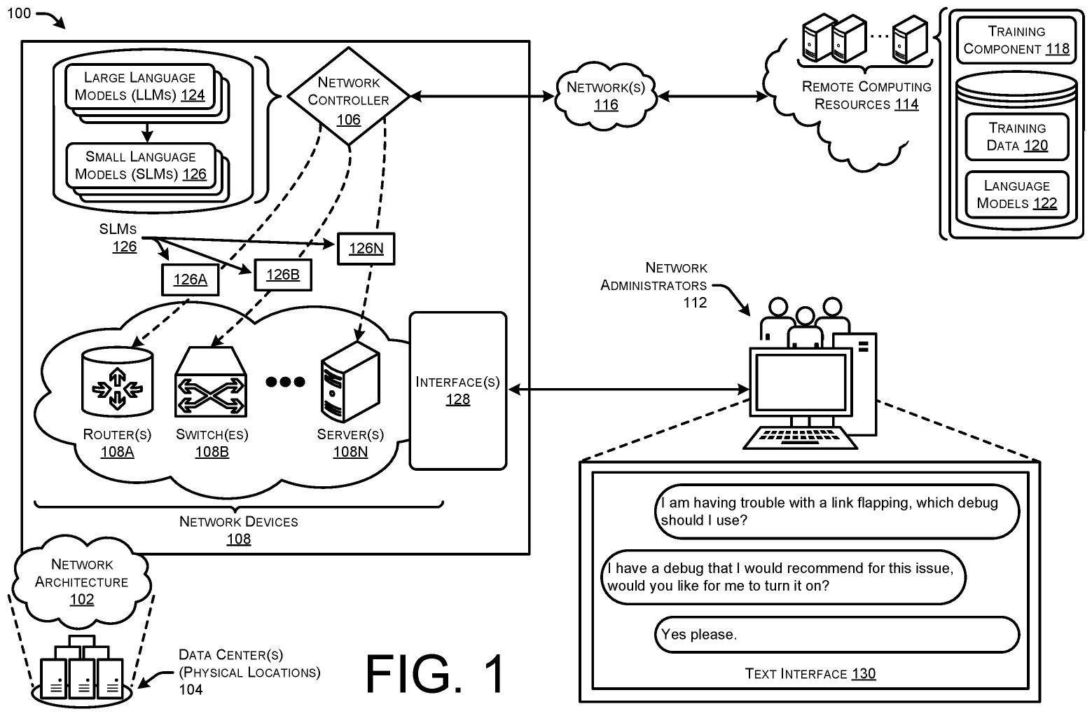

FIG. 1 illustrates a system-architecture diagram of an environment 100 in which a controller performs techniques for fine-tuning a language model to be optimized for a network device to which the language model is deployed.

The environment 100 may include a network architecture 102 that, in some examples, may comprise devices housed or located in one or more data centers 104. The network architecture 102 may include one or more networks implemented by any viable communication technology, such as wired and/or wireless modalities and/or technologies. The network architecture 102 may include any combination of Personal Area Networks (PANs), Local Area Networks (LANs), Campus Area Networks (CANs), Metropolitan Area Networks (MANs), extranets, intranets, the Internet, short-range wireless communication networks (e.g., ZigBee, Bluetooth, etc.) Wide Area Networks (WANs)—both centralized and/or distributed—and/or any combination, permutation, and/or aggregation thereof. The network architecture 102 may include devices, virtual resources, or other nodes that relay packets from one network segment to another by nodes in the computer network. The network architecture 102 may include multiple devices that utilize the network layer (and/or session layer, transport layer, etc.) in the OSI model for packet forwarding, and/or other layers. The network architecture 102 may include various network devices 108, such as routers 108A, switches 108B, gateways, firewalls, smart NICs, NICs, ASICs, FPGAs, servers 108N, and/or any other type of device. Further, the network architecture 102 may include virtual resources, such as VMs, containers, and/or other virtual resources. However, the network architecture 102 may be of a different type of architecture, such as a WAN, IoT network, cellular network, or any other type of network.

The one or more data centers 104 may be physical facilities or buildings located across geographic areas that designated to store networked devices that are part of the network architecture 102. The data centers 104 may include various networking devices, as well as redundant or backup components and infrastructure for power supply, data communications connections, environmental controls, and various security devices. In some examples, the data centers 104 may include one or more virtual data centers which are a pool or collection of cloud infrastructure resources specifically designed for enterprise needs, and/or for cloud-based service provider needs. Generally, the data centers 104 (physical and/or virtual) may provide basic resources such as processor (CPU), memory (RAM), storage (disk), and networking (bandwidth). However, in some examples the devices may not be located in explicitly defined data centers 104, but may be located in other locations or buildings.

The network controller 106 may perform various techniques for managing the network architecture 102 and the network devices 108 therein. For instance, the network controller 106 may manage network behavior and policies, network configuration and provisioning, traffic engineering and optimization, policy enforcement, visibility and monitoring, and other network management operations. In some examples, network administrators 112 work with the network controller 106 to ensure that their network architectures 102 are exhibiting desired characteristics, such as enforcing desired policies, implementing desired device configurations, or managing access to devices.

The network administrators 112 may connect to the network devices 108 via one or more interfaces 128 and once authenticated, can use the interface(s) 128 (e.g., CLIs) to issue prompts and commands for the network devices 108. However, CLI administration is clunky, inefficient, and generally slow unless the administrator has gained a mastery of the CLI over many years. For instance, network administrators 112 generally have to know what specific CLI commands to use in order to troubleshoot the network devices 108 and understand the results that are returned from the CLI commands, which are often difficult to understand. Accordingly, it can be difficult for the network administrators 112 to quickly and effectively interact with network devices 108 using CLIs.

There have been advances in artificial intelligence (AI) that have enabled chatbots and other AI systems to perform complex tasks that normally require human intelligence, such as perceiving, synthesizing, and inferring information. Generally speaking, AI systems and models ingest large amounts of data (or “training data”), analyze this data to identify correlations and patterns, and use these patterns to make predictions about future states. Although AI programs and algorithms have been around for decades, the amount of data and computing power needed to train AI models that are useful for humans has not existed. However, there have been various technological breakthroughs and advances that have accelerated the usefulness of AI, such as advent of cloud computing that provides effectively unlimited compute, advances in specialized hardware (e.g., graphics processing units (GPUs)) that efficiently train and run these AI models, and the discovery of more efficient training algorithms.

Generative AI is a type of artificial intelligence where models are used to create (or “generate”) new content based on inputs, often in the form of prompts from users. One type of generative AI model is particularly effective at generating text, specifically, the large language model (LLM). LLMs are trained on large sets or corpuses of text data to perceive and infer context from user queries, understand a broader range of queries, and generate human-like textual responses to the queries. Chatbots that are backed by LLMs are becoming increasingly popular among users due to their ability to perform complex tasks on behalf of users.

One type of neural network architecture that has gained popularity due to its ability to reduce the amount of time needed to train generative AI models is known as the Transformer model, or simply “Transformers. ” Transformers apply a set of mathematical techniques, called attention or self-attention, to capture relationships in sequential data called tokens, such as words in a sentence. Transformers are able to detect subtle causal relationships between data elements in a series, including how even distant data elements influence and depend on each other. Unlike previous models that have to process tokens sequentially (e.g., Recurrent Neural Networks (RNNs)), transformers use an attention mechanism to process tokens simultaneously and calculate the attention weights, or strengths of relationships, between the tokens in successive layers. Because transformers can compute attention weights for all the tokens in parallel, the amount of time needed to train generative AI models using transformers is greatly improved over other training models.

Generative AI can be used to generate text that resembles human-like responses to prompts. Transformers are very effective in training the models used generate text, often referred to as LLMs. LLMs are trained on large sets or corpuses of text data to generate human-like textual responses to prompts. LLMs are generally trained in two stages, pre-training and fine-tuning. During the pre-training stage, LLMs are trained on massive datasets of unlabeled text data (or “unsupervised learning”) where transformers allow the LLMs to process and learn the patterns and relationships between words. During the fine-tuning stage, the LLMs can be fine-tuned for specific tasks or prompts, such as summarizing content, answering questions, and text completion. There are generalized LLMs that have been trained on sets of text data describing all types of content (e.g., data obtained from crawlers that scrape the public Internet). There are also specialized LLMs that have been trained on specialized sets of data that are specific to a particular type of content, such as travel or shopping.

According to the techniques described herein, the network controller 106 may communicate with remote computing resources 114 that generate language models 122. In some instances, however, the network controller 106 itself may generate the language models 122, but in other examples, the language models 122 may be generated by the remote computing resources 114. The remote computing resources 114 may be a cloud computing platform, an on-premises computing resource, or other available computing resources. A training component 118 of the remote computing resources 114 may use training data 120 to allow the language models 122 to process and learn the patterns and relationships between words. The training data 120 may be many different types of data, such as network telemetry data, device configuration data, device state data, CLI commands and responses, event logs and debugs, and so forth. The language models 122 may be LLMs, SLMs, or any type of language model 122. The language models 122 may be generalized language models for different networks (e.g., WAN networks, data center networks, IoT networks, cellular networks), or may be specialized language models that have been trained on device-specific data (e.g., router language models, switch language models, sensor language models, etc.).

The remote computing resources 114 may provide the network controller 106 with access to the language models 122 over one or more networks 116, and the network controller 106 may provide portions of the training data 120 over the network(s) 116. The network(s) 116 may include any viable communication technology, such as wired and/or wireless modalities and/or technologies. Networks 116 may include any combination of Personal Area Networks (PANs), Local Area Networks (LANs), Campus Area Networks (CANs), Metropolitan Area Networks (MANs), extranets, intranets, the Internet, short-range wireless communication networks (e.g., ZigBee, Bluetooth, etc.) Wide Area Networks (WANs)—both centralized and/or distributed—and/or any combination, permutation, and/or aggregation thereof. The devices described herein may communicate using any type of protocol over the network 116, such as the transmission control protocol/Internet protocol (TCP/IP) that is used to govern connects to and over the Internet.

The network controller 106 may obtain LLMs 124 from the remote computing resources 114, in some examples. The LLMs 124 may be utilized according to the techniques described herein to augment interface(s) 128, such as a CLI, and assist network administrators 112 that are interacting with network devices 108, such as by interpreting debugs, investigating on-board logs, explaining configuration snippets, and even generating CLI commands on behalf of admins. However, LLMs 124 generally require large amounts of computing resources to run, and often require specialized hardware (e.g., graphic processing units (GPUs) to efficiently run.

There have been many developments in large-scale machine learning and deep learning models. For example, Generative Pretrained Models version 3 (GPT-3) is trained on 570 GB of text and consists of 175 billion parameters. While large models may have state-of-the-art performance, in various scenarios described herein it may be desirable to deploy a smaller model. Knowledge distillation is a technique that transfers knowledge from a complex neural network (the “teacher model”) to a simpler one (the “student model”). The teacher model is trained on labeled data, and the student model is trained to mimic the teacher's behavior using unlabeled data of “soft targets”, which are probability distributions indicating the teacher's confidence in its predictions. By minimizing the difference between the student's predictions and the teacher's soft targets, the student model can learn from the teacher's knowledge and achieve similar or better performance, even with fewer parameters.

The network devices 108 are often resource-constrained devices, such as switches 108B, routers 108A, or firewalls, which makes it very difficult or impossible to run an LLM 124 locally on these devices. Even for inference applications, network devices 108 do not have GPUs that are needed to accelerate token generation. In addition to being very large and resource intensive, the off-the-shelf open-source LLMs 124 do not have contextually relevant fine-tuning to be useful on these network devices 108.

The techniques described herein include creating fine-tuned, SLMs 126 that are optimized for the roles or device types of the network devices 108 to which they are deployed. In some examples, the network controller 106 for the network architecture 102 may obtain a catalogue or group of pre-trained language models 122 from the remote computing resources 114, such as LLMs 124. Each of the pre-trained models may be trained for different types of networks (e.g., WANs, data center networks, IoT networks, etc.), and/or for different types of devices (e.g., firewalls, switches, routers, etc.). Each pre-trained model may cover or be trained on the vocabulary (e.g., configuration, debugs, etc.) of each device type based on its capabilities and functionalities.

The network controller 106 may maintain an inventory or catalogue of the different network devices 108 in the network architecture 102 and may further obtain device information for the network devices 108. For instance, the network controller 106 may use various commands to obtain comprehensive diagnostic reports from network devices 108 (e.g., “show tech” command). The device information may include hardware information, software versions, configurations of the network devices (e.g., settings for interfaces, routing protocols, security features, etc.), system resources (e.g., utilization of CPU or memory, buffer pools, etc.), status information, routing and switching information logs and events, diagnostic and debugging information, and various types of telemetry data. The network controller 106 may examine the details for each network device 108 and determine the device types or roles of the devices, the hardware model, the capabilities of the devices, the resource constraints of the devices (e.g., supports 10B parameters, maximum of 3.5 Gigabytes (GB) of memory, 20 tokens of processing speed, etc.), and what services or features the network device 108 is using (e.g., Layer 2 (L2) or L3 security, Quality of Services (QoS) policies, overlay services, routing protocols, etc.).

After analyzing this various information for a network device 108, the network controller 106 may select a pre-trained model that is best suited for the type of device. For instance, the network controller 106 may select an LLM 124 that is pre-trained for a firewall device if the network controller 106 is deploying the model to a firewall. However, the LLM 124 that is selected may require more resources to run than that available or permitted by the network device 108. In such examples, the network controller 106 may perform a distillation function for the model to make a smaller, more refined model. For example, based on the device information for the network device 108, the network controller 106 may determine what services are in use.

For instance, a router 108A may be using the OSPF routing protocol, but it may not be configured to use other routing protocols, such IS-IS routing protocol, EIGRP, or BGP. The network controller 106 may execute a model distillation process to reduce the size or number of parameters, while retaining much of the LLM's performance. For instance, the SLM 126 that is generated for the router 108A discussed above may be distilled to remove knowledge or parameters related to IS-IS, EIGRP, and BGP because the router 108A is not configured to use those protocols. In some examples, depending on the resources of the network device 108, the network controller 106 may use model quantization techniques to alter the floating-point values used in tokenization to better suit resources of the networking device 108. In this way, the network controller 106 is able to create a fine-tuned, and distilled model for the network device 108.

Depending on the capabilities of the network controller 106, the network controller 106 may perform the distillation function on its own (if it's loaded with GPUs), or it may use a cloud resource for this element of fine-tuning. Additionally, other model trimming techniques may be used to reduce the size of the LLMs 124, such as model pruning and removing the unused vocabulary (e.g., vocabulary on BGP that has a low probability of being associated to the OSPF vocabulary on a router that has OSPF configured, but not BGP).

After the LLM 124 has been distilled or otherwise has had its size reduced, the network controller 106 may augment the SLM 126 with locally relevant information. Specifically, the device information obtained for the network device 108 may be used to further fine-tune the model. For example, the network controller 106 may augment the SLM 126 with new data, features, or functionalities determined using the device information. The SLM 126 may be augmented with data related to new features of the network device 108, locally relevant state information, local configurations not represented in the SLM 126, and so forth.

Alternatively, RAG, or a similar technique, could be used to make the SLM 126 locally and contextually relevant for each device. For instance, the device information may be converted into embeddings using an embedding model, and the embeddings may be entered into a vector database stored locally on the network device 108. In some instances, rather than using an embedding model and vector database, the device information for a context window may be retrieved by querying local application programming interfaces (APIs) that return the locally relevant context information that may be provided to the SLMs 126.

With the SLM 126 now fine-tuned, the network controller 106 may pre-position the SLM 126 on the network device 108 so network administrators 112 can access it if and when necessary. The SLM 126 may be used as a type of chatbot that receives prompts from network administrators 112 on behalf of, or in conjunction with, the CLIs. In some examples, the SLMs 126 may allow network administrators 112 to submit queries or prompts in natural languages, rather than using CLI commands. In some instances, the network controller 106 may occasionally refresh the distillation and/or fine tuning of the local SLM 126 on the device in the remote computing resources 114 and replace the current model as new features are introduced. In this way, the techniques described herein result in the deployment of SLMs 126 on network devices 108 that are tuned to the computing capabilities, local context, and configurations of the network devices 108 and potentially networks in which the devices are deployed.

The interface(s) 128 may comprise any type of interface, such as CLIs, APIs, Graphical User Interfaces (GUIs), Web-Based Interfaces, voice interfaces, scripting languages, embedded interfaces, middleware platforms, and so forth. As shown, the network administrators 112 may utilize a text interface 130 to communicate with the network devices 108 via the interface(s) 128. The text interface 130 may be any type of interface, including CLIs, chatbots, etc. In this example, the network administrators 112 may present a prompt via the text interface 130 of “I am having trouble with a link flapping, which debug should I use?” As shown, the prompt is a natural language prompt, and not a specific CLI command. Further, the prompt is a question for the network device 108 to answer. The SLM 126 on the network device 108 may then determine a response to the prompt/query, and respond with “I have a debug that I would recommend for this issue, would you like for me to turn it on?” Thus, the SLM 126 may determine an answer and solution, and response with a natural language answer. The network administrator 112 may respond with an affirmative answer for the network device 108 to implement the debug, and the issue may be resolved. In some examples, the solution determined by the SLM 126 may be determined using locally relevant contextual data that is relevant to that device (e.g., error logs, protocols in use, etc.).

While some of the techniques are described herein as being performed by the network controller 106, some or all of the techniques may be performed by other devices. For instance, a dedicated service may be created for the network architecture 102 that performs the techniques, and/or a remote service may be employed, such as a cloud-based service, to perform some or all of the techniques. Further, while the techniques are described with respect to LLMs 124 and SLMs 126, any type of models may be used. That is, the models may not necessarily comply with the definitions of LLMs 124 and SLMs 126, but the general idea of distilling or reducing the size of the initial model into a smaller model (less memory required to store) is included in the techniques of this disclosure. An LLM 124 may simply be any model that is larger than the SLM 126 that is placed on the network devices 108, but the models themselves may not necessarily comply with industry definitions of LLMs 124 and SLMs 126. For instance, the models may both technically be SLMs 126, but the model deployed to the network device 108 may simply be smaller than the initial model being considered.

The network administrators 112 may establish communication connections over the one or more networks 116 to communicate with devices in the network architecture 102, such as the network controller 106 of the network architecture 102 and the network devices 108. The network(s) 116 may include any viable communication technology, such as wired and/or wireless modalities and/or technologies. Networks 116 may include any combination of Personal Area Networks (PANs), Local Area Networks (LANs), Campus Area Networks (CANs), Metropolitan Area Networks (MANs), extranets, intranets, the Internet, short-range wireless communication networks (e.g., ZigBee, Bluetooth, etc.) Wide Area Networks (WANs)—both centralized and/or distributed—and/or any combination, permutation, and/or aggregation thereof. The network administrators 112 may communicate using any type of protocol over the network 116, such as the transmission control protocol/Internet protocol (TCP/IP) that is used to govern connects to and over the Internet.

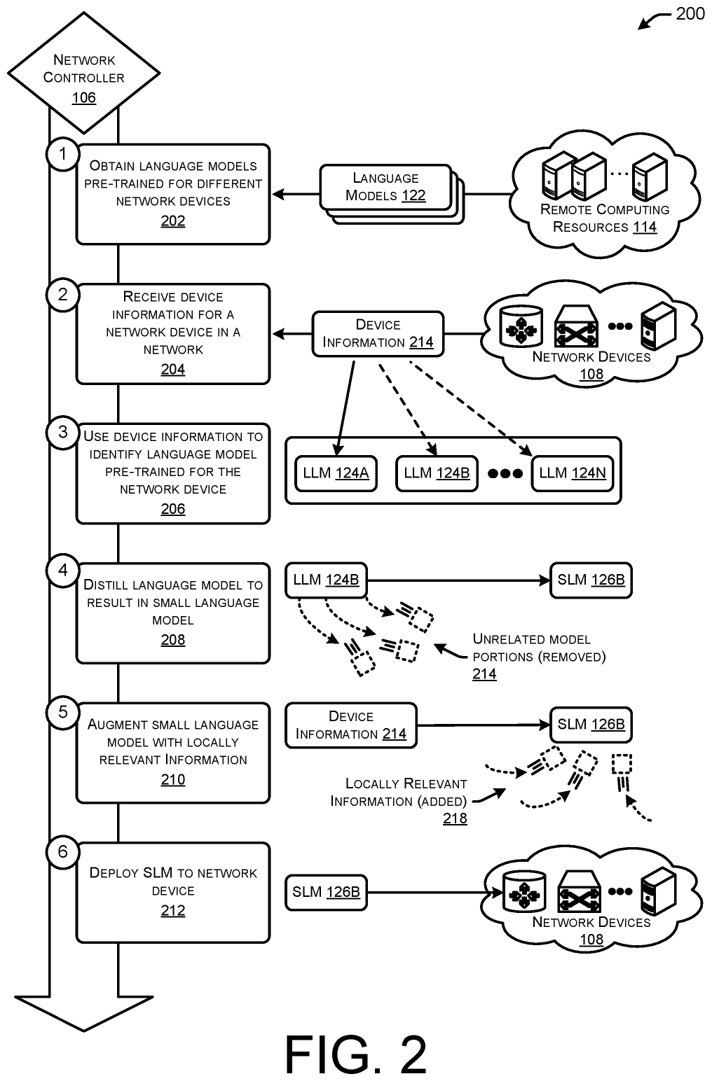

FIG. 2 illustrates a flow diagram 200 of an example method for fine-tuning a language model to be optimized for a network device to which the language model is deployed.

At 202, the network controller 106 may obtain language models that are pre-trained for different network devices (e.g., routers, switches, firewalls, etc.), and/or generic models that are trained for different networks (e.g., WAN, data centers, IoT, etc.). In some instances, the network controller 106 may communicate with remote computing resources 114 that generates language models 122. In some instances, however, the network controller 106 itself may generate the language models 122, but in other examples, the language models 122 may be generated by the remote computing resources 114.

At 204, the network controller 106 may receive device information 214 for a network device 108 in the network architecture 102. For instance, the network controller 106 may use various commands to obtain comprehensive diagnostic reports from network devices 108 (e.g., “show tech” command). The device information 214 may include hardware information, software versions, configurations of the network devices (e.g., settings for interfaces, routing protocols, security features, etc.), system resources (e.g., utilization of CPU or memory, buffer pools, etc.), status information, routing and switching information logs and events, diagnostic and debugging information, and various types of telemetry data.

At 206, the network controller 106 may examine the device information 214 and details for each network device 108 and determine the device types or roles of the network devices 108, and potentially the hardware model, the capabilities of the devices, the resource constraints of the devices (e.g., supports 10B parameters, maximum of 3.5 Gigabytes (GB) of memory, 20 tokens of processing speed, etc.), and what services or features the network device 108 is using (e.g., Layer 2 (L2) or L3 security, Quality of Services (QoS) policies, overlay services, routing protocols, etc.).

After analyzing this various information for a network device 108, the network controller 106 may select a pre-trained model that is best suited for the type of device. For instance, the network controller 106 may select an LLM 124 that is pre-trained for a firewall device if the network controller 106 is deploying the model to a firewall. However, the LLM 124 that is selected may require more resources to run than that available or permitted by the network device 108.

At 208, the network controller 106 (if it is loaded with GPUs) may perform a distillation function for the model to make a smaller, more refined model. In some examples, however, the network controller 106 may offload the distillation function to other resources, such as the remote computing resources 114. Based on the device information 214 for the network device 108, the network controller 106 may determine what services are in use. In an illustrative example, a router 108A may be using the OSPF routing protocol, but it may not be configured to use other routing protocols, such IS-IS routing protocol, EIGRP, or BGP. The network controller 106 may execute a model distillation process to reduce the size or number of parameters, while retaining much of the LLM's performance. For instance, the SLM 126 that is generated for the router 108A discussed above may be distilled to remove knowledge or parameters related to IS-IS, EIGRP, and BGP because the router 108A is not configured to use those protocols. In some examples, depending on the resources of the network device 108, the network controller 106 may use model quantization techniques to alter the floating-point values used in tokenization to better suit resources of the networking device 108. In this way, the network controller 106 is able to create a fine-tuned, and distilled model for the network device 108.

Depending on the capabilities of the network controller 106, the network controller 106 may perform the distillation function on its own (if it's loaded with GPUs), or it may use a cloud resource for this element of fine-tuning. Additionally, other model trimming techniques may be used to reduce the size of the LLMs 124, such as model pruning and removing the unused vocabulary (e.g., vocabulary on BGP that has a low probability of being associated to the OSPF vocabulary on a router that has OSPF configured, but not BGP).

At 210, the network controller 106 may augment the SLM 126 with locally relevant information, which may be information included in the device information 214. Specifically, the device information 214 obtained for the network device 108 may be used to further fine-tune the model. For example, the network controller 106 may augment the SLM 126 with new data, features, or functionalities determined using the device information. The SLM 126 may be augmented with data related to new features of the network device 108, locally relevant state information, local configurations not represented in the SLM 126, and so forth. Alternatively, RAG, or a similar technique, could be used to make the SLM 126 locally and contextually relevant for each device. For instance, the device information 214 may be converted into embeddings using an embedding model, and the embeddings may be entered into a vector database stored locally on the network device 108. In some instances, rather than using an embedding model and vector database, the device information for a context window may be retrieved by querying local application programming interfaces (APIs) that return the locally relevant context information that may be provided to the SLMs 126.

At 212, the network controller 106 may deploy the SLM 126 to the network device 108. With the SLM 126 now fine-tuned, the network controller 106 may pre-position the SLM 126 on the network device 108 so network administrators 112 can access it if and when necessary. The SLM 126 may be used as a type of chatbot that receives prompts from network administrators 112 on behalf of, or in conjunction with, the CLIs. In some examples, the SLMs 126 may allow network administrators 112 to submit queries or prompts in natural languages, rather than using CLI commands. In some instances, the network controller 106 may occasionally refresh the distillation and/or fine tuning of the local SLM 126 on the device in the remote computing resources 114 and replace the current model as new features are introduced. In this way, the techniques described herein result in the deployment of SLMs 126 on network devices 108 that are tuned to the computing capabilities, local context, and configurations of the network devices 108 and potentially networks in which the devices are deployed.

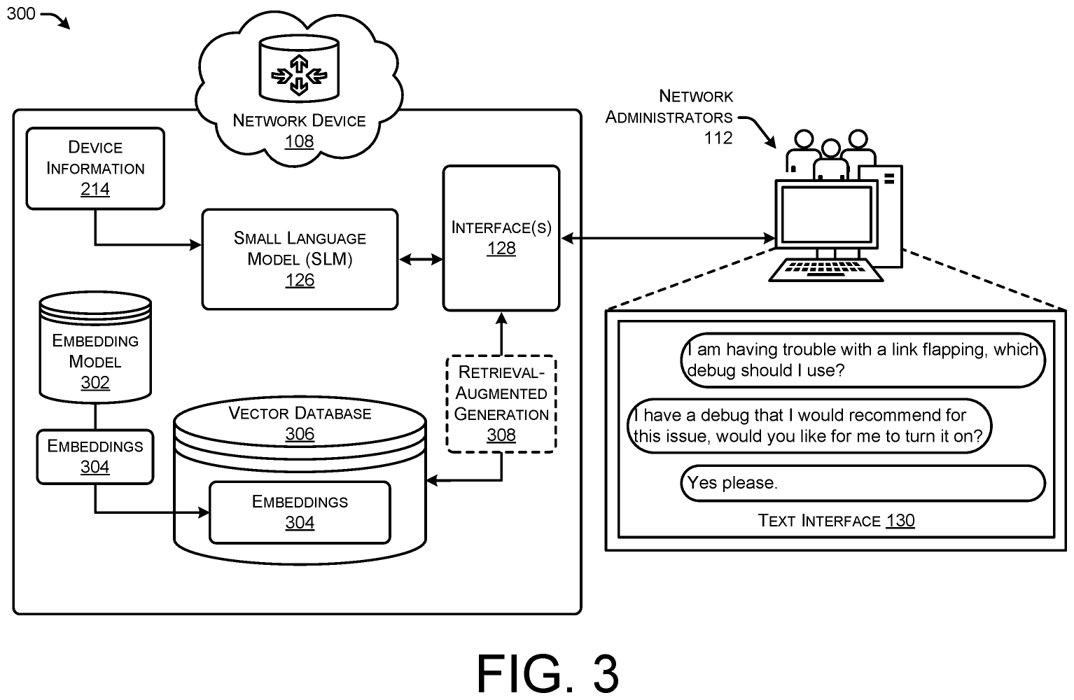

FIG. 3 illustrates an example diagram 300 of a network device 108 that uses RAG to obtain embeddings from a vector database to provide a SLM 126 that responds to prompts from network administrators 112.

The interface(s) 128 of the network device 108 may include a front-end module that facilitates and coordinates at least some of the techniques described in FIG. 3. The front-end module may receive text commands, prompts, queries, etc. (referred to herein collectively as “prompts”), from the network administrators 112 computing devices. In some instances, the front-end module may simply provide the prompts to the SLM 126 in order to get a response from the SLM 126 for the prompts. The responses may then be provided back to the network administrators 112 as part of a natural language conversation.

In some instances, an embedding model 302 may be used to generate embeddings 304 that are stored in a vector database 306. Although illustrated as being located on the network device 108, the embedding model 302 may be located and run on other devices, such as the network controller 106, the remote computing resources 114, other devices, or a combination thereof.

The embedding model 302 may be any type of model configured to generate embeddings 304 by mapping text data, such as words, phrases, or sentences, into vector spaces. The resulting embeddings 304 capture semantic and syntactic information about the data, allowing models to work with and compare various forms of input more effectively. Various types of embedding models 302 may be used to create the embeddings 304, such as word embeddings (e.g., Word2Vec, GloVe, etc.) that are trained to predict the context of a word (or vice versa), leading to embeddings that capture semantic similarities between words, as well as contextual embeddings (e.g., BERT, GPT, etc.), or models that use neural networks to understand the context in which words appear. The embeddings are dynamically generated based on surrounding words and the specific sentence or passage, capturing more nuanced meanings and relationships. The embedding model 302 may analyze the device information 214 and/or other data in order to generate the embeddings 304. The resulting embeddings 304 may be stored in the vector database 306 where semantically similar words (or tokens) are located closer together in the vector space.

The embeddings stored in the vector database 306 may be used by the front-end module for RAG 308 processes. The front-end module may initially retrieve relevant information from the vector database 306 using the prompts from the network administrators 112. This retrieval step may include the use of a retrieval model to search for documents or pieces of information that are most pertinent to the input query or context (e.g., cosine similarity, Euclidean distance, etc.). The front-end module may then perform an augmentation step where the retrieved words or documents from the vector database 306 (e.g., embeddings 304) determined as relevant to the prompt is used to augment the prompt as it is placed into a context window of the SLM 126. In this way, the SLM 126 may be provided with additional, locally relevant information that can be used to generate more accurate and contextually appropriate responses. The SLM 126 may then use the augmented prompt to produce a response. The resulting response benefits from the specific and relevant details provided by the retrieval step, improving its quality and relevance. The responses may then be provided to the network administrators 112 such that the responses are locally and contextually relevant to the specific network device 108.

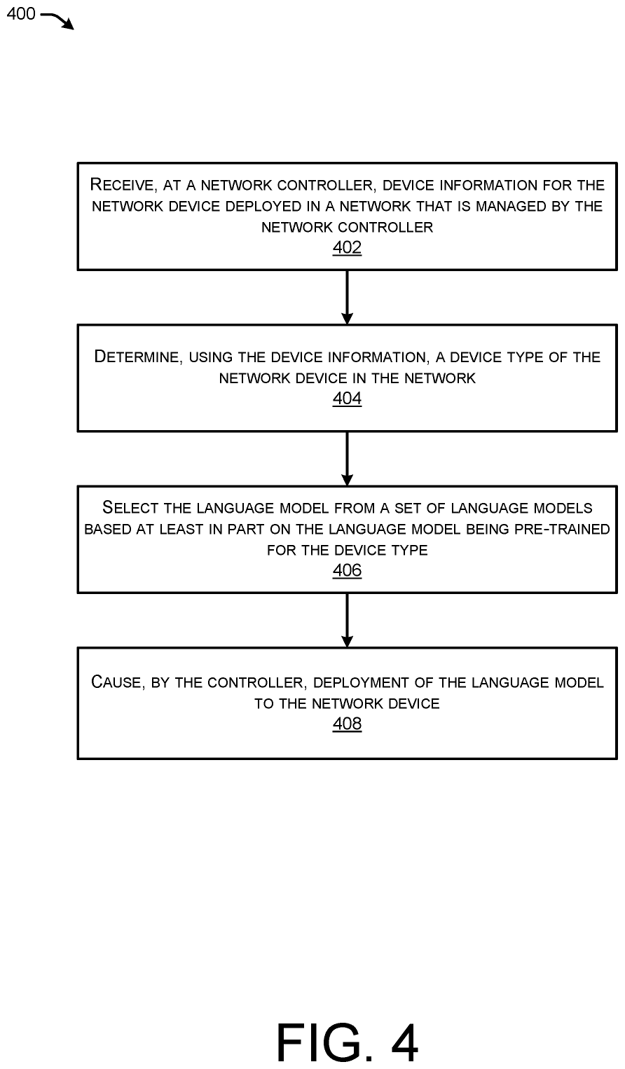

FIGS. 4-7 illustrate flow diagrams of an example methods 400, 500, 600, and 700 that illustrates aspect of the functions performed at least partly by the devices described in FIGS. 1-3, such as the network controller 106, the remote computing resources 14, and/or the network devices 108. The logical operations described herein with respect to FIGS. 4-7 may be implemented (1) as a sequence of computer-implemented acts or program modules running on a computing system and/or (2) as interconnected machine logic circuits or circuit modules within the computing system.

The implementation of the various components described herein is a matter of choice dependent on the performance and other requirements of the computing system. Accordingly, the logical operations described herein are referred to variously as operations, structural devices, acts, or modules. These operations, structural devices, acts, and modules can be implemented in software, in firmware, in special purpose digital logic, and any combination thereof. It should also be appreciated that more or fewer operations might be performed than shown in the FIGS. 4-7 and described herein. These operations can also be performed in parallel, or in a different order than those described herein. Some or all of these operations can also be performed by components other than those specifically identified. Although the techniques described in this disclosure is with reference to specific components, in other examples, the techniques may be implemented by less components, more components, different components, or any configuration of components.

In some instances, the steps of methods 400-700 may be performed by a device and/or a system of devices that includes one or more processors and one or more non-transitory computer-readable media storing computer-executable instructions that, when executed by the one or more processors, cause the one or more processors to perform operations of methods 400-700.

FIG. 4 illustrates a flow diagram of an example method 400 for selecting a language model for a network device 108 based on the language model being pre-trained for a device type of the network device.

At 402, the network controller 106 may receive device information 214 for the network device 108 deployed in a network that is managed by the network controller 106. The device information 214 may, in some examples, include locally relevant information specific to the network device 108.

At 404, the network controller 106 may determine, using the device information 214, a device type of the network device 108 in the network (e.g., server, switch, firewall, IoT sensor, mobile phone, etc.).

At 406, the network controller 106 may select a language model from a set of language models based at least in part on the language model being pre-trained for the device type. The language model may be an LLM, an SLM, or another language model.

In some instances, the method 400 may further include distilling the language model to result in a distilled language mode. The distilling may comprise, using the device information, identifying a portion of the language model that is unrelated to functionality of the network device, and removing the portion of the language model. In such examples, the distilled language model requires less memory to store than the language model.

In various examples, the method 400 may include augmenting the distilled language model with locally relevant information specific to the network device 108 such that the distilled language model is contextually relevant for the network device 108.

At 408, the network controller 106 may cause deployment of the language model to the network device 108.

In some instances, the method 400 may include, using an embedding model, generating embeddings 304 representing the device information 214 where the device information includes locally relevant information specific to the network device. The method 400 may further include storing, in a vector database 306, the embeddings representing the device information, and configuring the language model to receive the device information from the vector database using retrieval-augmented generation (RAG).

In some instances, the method 400 may include determining that a new feature has been implemented in the network device, receiving an updated language model that is pre-trained to answer queries related to the new feature, and causing, by the controller, deployment of the updated language model to the network device.

In some instances, the method may further include receiving an indication of computing resource constraints of the network device, and in such examples, the language model is selected based at least in part on it complying with the computing resource constraints of the network device.

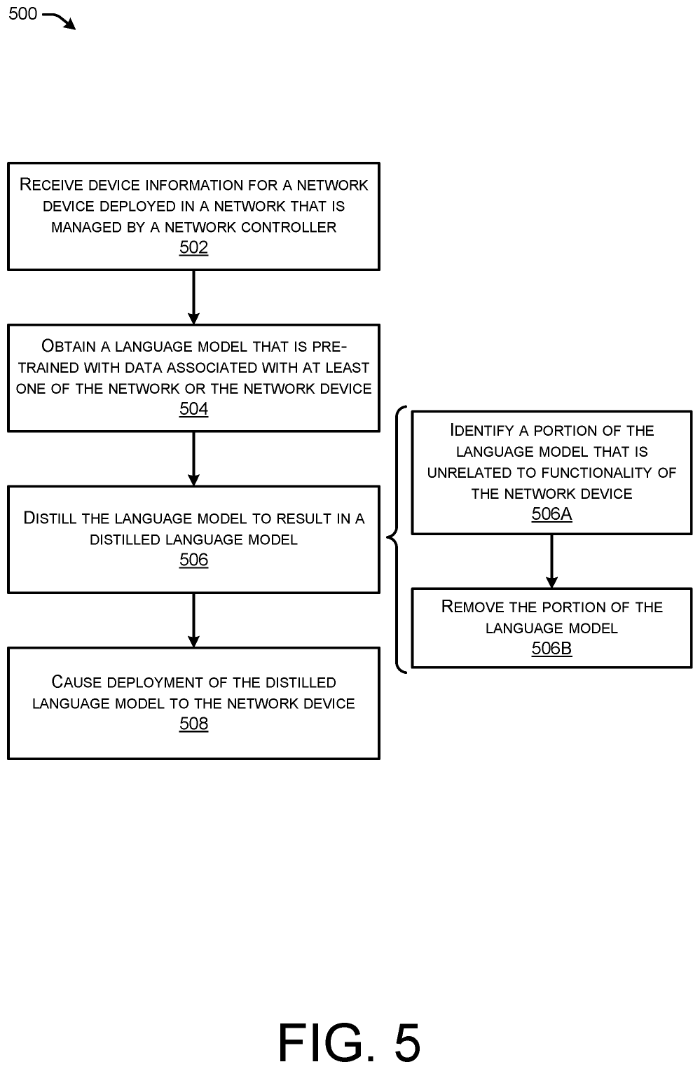

FIG. 5 illustrates a flow diagram of an example method 500 for distilling a language model to reduce the size of the language model for deployment to a network device.

At 502, a network controller 106 may receiving device information for a network device deployed in a network that is managed by a network controller,

At 504, a network controller 106 may obtain a language model that is pre-trained with data associated with at least one of the network or the network device.

At 506, a network controller 106 may distill the language model to result in a distilled language model where the distilling comprises, using the device information, identifying a portion of the language model that is unrelated to functionality of the network device, and removing the portion of the language model. In such examples, the distilled language model requires less memory to store than the language model.

At 508, a network controller 106 may cause deployment of the distilled language model to the network device.

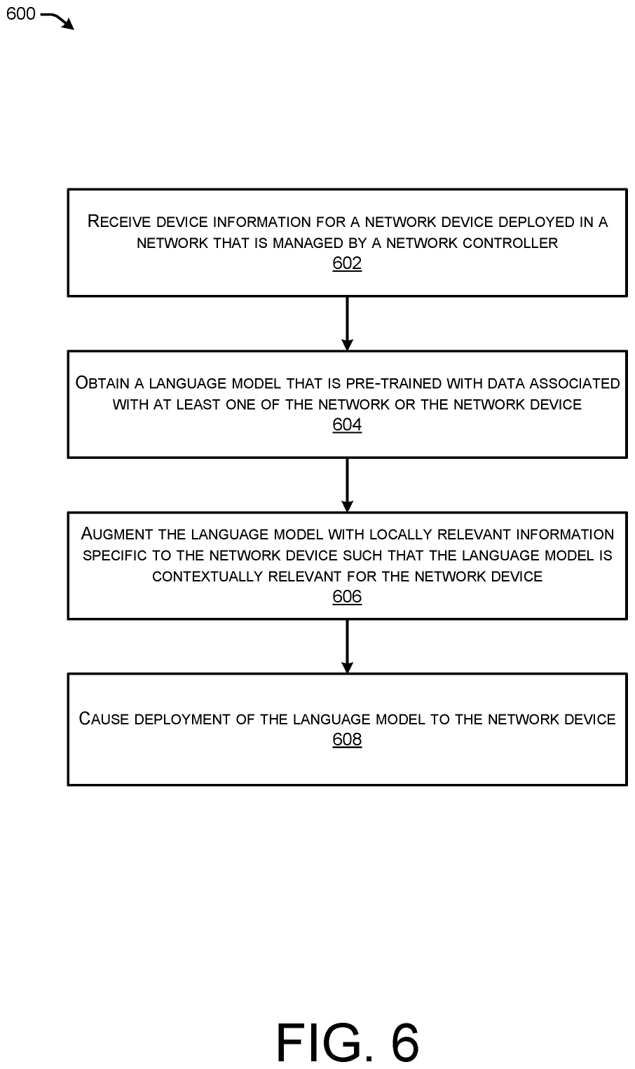

FIG. 6 illustrates a flow diagram of an example method 600 for augmenting a language model using locally relevant information for a network device 108 such that the language model is contextually relevant for the network device 108.

At 602, the network controller 106 may receive device information 214 for the network device 108 deployed in a network that is managed by the network controller 106. The device information 214 may, in some examples, include locally relevant information specific to the network device 108.

At 604, a network controller 106 may obtain a language model that is pre-trained with data associated with at least one of the network or the network device.

At 606, the network controller 106 may augment the language model with locally relevant information specific to the network device such that the language model is contextually relevant for the network device.

At 608, a network controller 106 may cause deployment of the distilled language model to the network device.

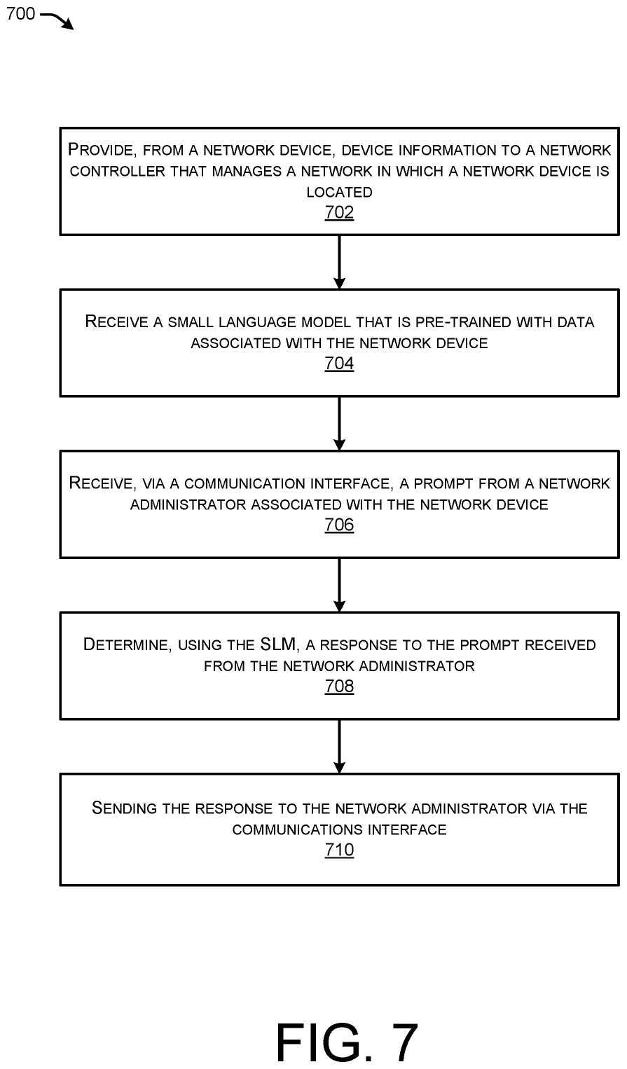

FIG. 7 illustrates a flow diagram of an example method 700 for a network device 108 to receive a language model and respond to a prompt of a network administrator 112 using the language model.

At 702, a network device 108 may provide device information to a network controller that manages a network in which a network device is located. At 704, a network device 108 may receive a small language model that is pre-trained with data associated with the network device.

At 706, a network device 108 may receive, via a communication interface, a prompt from a network administrator associated with the network device. At 708, a network device 108 may determine, using the SLM, a response to the prompt received from the network administrator. At 710, a network device 108 may send the response to the network administrator via the communications interface.

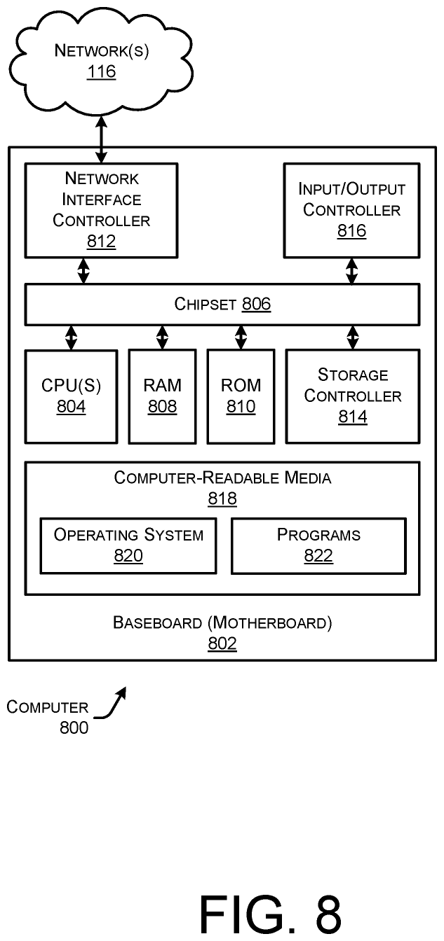

FIG. 8 shows an example computer architecture for a device capable of executing program components for implementing the functionality described above. The computer architecture shown in FIG. 8 illustrates any type of computer 800, such as a conventional server computer, workstation, desktop computer, laptop, tablet, network appliance, e-reader, smartphone, or other computing device, and can be utilized to execute any of the software components presented herein.

As described herein, the network controller 106 may be run on the computer 800, or multiple computers 800. Similarly, the computer 800 may be any type of network device 108 described herein. Thus, the computer 800 may, in some examples, correspond to any device described herein, and may comprise personal devices (e.g., smartphones, tables, wearable devices, laptop devices, etc.) networked devices such as servers, switches, routers, hubs, bridges, gateways, modems, repeaters, access points, and/or any other type of computing device that may be running any type of software and/or virtualization technology.

The computer 800 includes a baseboard 802, or “motherboard,” which is a printed circuit board to which a multitude of components or devices can be connected by way of a system bus or other electrical communication paths. In one illustrative configuration, one or more central processing units (“CPUs”) 804 operate in conjunction with a chipset 806. The CPUs 804 can be standard programmable processors that perform arithmetic and logical operations necessary for the operation of the computer 800.

The CPUs 804 perform operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

The chipset 806 provides an interface between the CPUs 804 and the remainder of the components and devices on the baseboard 802. The chipset 806 can provide an interface to a RAM 808, used as the main memory in the computer 800. The chipset 806 can further provide an interface to a computer-readable storage medium such as a read-only memory (“ROM”) 810 or non-volatile RAM (“NVRAM”) for storing basic routines that help to startup the computer 800 and to transfer information between the various components and devices. The ROM 810 or NVRAM can also store other software components necessary for the operation of the computer 800 in accordance with the configurations described herein.

The computer 800 can operate in a networked environment using logical connections to remote computing devices and computer systems through a network, such as the network 116. The chipset 806 can include functionality for providing network connectivity through a NIC 812, such as a gigabit Ethernet adapter. The NIC 812 is capable of connecting the computer 800 to other computing devices over the network 116. It should be appreciated that multiple NICs 812 can be present in the computer 800, connecting the computer to other types of networks and remote computer systems.

The computer 800 can be connected to a storage device 818 that provides non-volatile storage for the computer. The storage device 818 can store an operating system 820, programs 822, and data, which have been described in greater detail herein. The storage device 818 can be connected to the computer 800 through a storage controller 814 connected to the chipset 806. The storage device 818 can consist of one or more physical storage units. The storage controller 814 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

The computer 800 can store data on the storage device 818 by transforming the physical state of the physical storage units to reflect the information being stored. The specific transformation of physical state can depend on various factors, in different embodiments of this description. Examples of such factors can include, but are not limited to, the technology used to implement the physical storage units, whether the storage device 818 is characterized as primary or secondary storage, and the like.

For example, the computer 800 can store information to the storage device 818 by issuing instructions through the storage controller 814 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computer 800 can further read information from the storage device 818 by detecting the physical states or characteristics of one or more particular locations within the physical storage units.

In addition to the mass storage device 818 described above, the computer 800 can have access to other computer-readable storage media to store and retrieve information, such as program modules, data structures, or other data. It should be appreciated by those skilled in the art that computer-readable storage media is any available media that provides for the non-transitory storage of data and that can be accessed by the computer 800. In some examples, the operations performed by the network controller 106, the network device 108, and or any components included therein, may be supported by one or more devices similar to computer 800. Stated otherwise, some or all of the operations performed by network controller 106 and/or the network device 108, and or any components included therein, may be performed by one or more computer devices 800.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage device 818 can store an operating system 820 utilized to control the operation of the computer 800. According to one embodiment, the operating system comprises the LINUX operating system. According to another embodiment, the operating system comprises the WINDOWS® SERVER operating system from MICROSOFT Corporation of Redmond, Washington. According to further embodiments, the operating system can comprise the UNIX operating system or one of its variants. It should be appreciated that other operating systems can also be utilized. The storage device 818 can store other system or application programs and data utilized by the computer 800.

In one embodiment, the storage device 818 or other computer-readable storage media is encoded with computer-executable instructions which, when loaded into the computer 800, transform the computer from a general-purpose computing system into a special-purpose computer capable of implementing the embodiments described herein. These computer-executable instructions transform the computer 800 by specifying how the CPUs 804 transition between states, as described above. According to one embodiment, the computer 800 has access to computer-readable storage media storing computer-executable instructions which, when executed by the computer 800, perform the various processes described above with regard to FIGS. 1-14. The computer 800 can also include computer-readable storage media having instructions stored thereupon for performing any of the other computer-implemented operations described herein.

The computer 800 can also include one or more input/output controllers 816 for receiving and processing input from a number of input devices, such as a keyboard, a mouse, a touchpad, a touch screen, an electronic stylus, or other type of input device. Similarly, an input/output controller 816 can provide output to a display, such as a computer monitor, a flat-panel display, a digital projector, a printer, or other type of output device. It will be appreciated that the computer 800 might not include all of the components shown in FIGS. 2 and/or 3, can include other components that are not explicitly shown in FIG. 8, or might utilize an architecture completely different than that shown in FIG. 8.

As described herein, the computer 800 may comprise one or more of a network controller 106, the network device 108, and/or any other device. The computer 800 may include one or more hardware processors 804 (processors) configured to execute one or more stored instructions. The processor(s) 804 may comprise one or more cores. Further, the computer 800 may include one or more network interfaces configured to provide communications between the computer 800 and other devices, such as the communications described herein as being performed by the network controller 106 and/or the network device 108. The network interfaces may include devices configured to couple to personal area networks (PANs), wired and wireless local area networks (LANs), wired and wireless wide area networks (WANs), and so forth. For example, the network interfaces may include devices compatible with Ethernet, Wi-Fi™, and so forth.

The programs 822 may comprise any type of programs or processes to perform the techniques described in this disclosure.

While the invention is described with respect to the specific examples, it is to be understood that the scope of the invention is not limited to these specific examples. Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Although the application describes embodiments having specific structural features and/or methodological acts, it is to be understood that the claims are not necessarily limited to the specific features or acts described. Rather, the specific features and acts are merely illustrative some embodiments that fall within the scope of the claims of the application.

What is claimed is:

1. A method for fine-tuning a language model to be optimized for a network device to which the language model is deployed, the method comprising:
receiving, at a network controller, device information for the network device deployed in a network that is managed by the network controller;
determining, using the device information, a device type of the network device in the network;
selecting the language model from a set of language models based at least in part on the language model being pre-trained for the device type; and
causing, by the network controller, deployment of the language model to the network device.

2. The method of claim 1, further comprising:
distilling the language model to result in a distilled language model, the distilling comprising:
using the device information, identifying a portion of the language model that is unrelated to functionality of the network device; and
removing the portion of the language model,
wherein the distilled language model requires less memory to store than the language model.

3. The method of claim 2, further comprising augmenting the distilled language model with locally relevant information specific to the network device such that the distilled language model is contextually relevant for the network device.

4. The method of claim 1, further comprising:
using an embedding model, generating embeddings representing the device information, wherein the device information includes locally relevant information specific to the network device;
storing, in a vector database, the embeddings representing the device information; and
configuring the language model to receive the device information from the vector database using retrieval-augmented generation (RAG).

5. The method of claim 1, further comprising:
determining, by the network controller, that a new feature has been implemented in the network device;
receiving an updated language model that is pre-trained to answer queries related to the new feature; and
causing, by the network controller, deployment of the updated language model to the network device.

6. The method of claim 1, further comprising:
receiving an indication of computing resource constraints of the network device,
wherein the language model is selected based at least in part on it complying with the computing resource constraints of the network device.

7. The method of claim 1, further comprising:
receiving, at the network controller, second device information for a second network device deployed in the network;
determining, using the second device information, a second device type of the second network device in the network;
selecting a second language model from the set of language models based at least in part on the second language model being pre-trained for the second device type; and
causing, by the network controller, deployment of the second language model to the second network device, wherein the second language model is different than the language model.

8. A system comprising:
one or more processors; and
one or more non-transitory computer-readable media storing computer-executable instructions that, when executed by the one or more processors, cause the one or more processors to perform operations comprising:
receiving device information for a network device deployed in a network that is managed by a network controller;
obtaining a language model that is pre-trained with data associated with at least one of the network or the network device;
distilling the language model to result in a distilled language model, the distilling comprising:
using the device information, identifying a portion of the language model that is unrelated to functionality of the network device; and
removing the portion of the language model, wherein the distilled language model requires less memory to store than the language model; and
causing deployment of the distilled language model to the network device.

9. The system of claim 8, wherein:
the language model is a generic language model that is pre-trained for a plurality of network devices; and
the portion of the language model that is removed from the language model is related to different functionality related to a different network device.

10. The system of claim 8, the operations further comprising:
determining, using the device information, a device type of the network device in the network; and
selecting the language model from a set of language models based at least in part on the language model being pre-trained for the device type.

11. The system of claim 8, the operations further comprising:
obtaining state and configuration data for the network device; and
augmenting the distilled language model with the state and configuration data such that the distilled language model is contextually relevant for the network device.

12. The system of claim 8, the operations further comprising:
determining that a new feature has been implemented in the network device;
receiving an updated language model that is pre-trained to answer queries related to the new feature; and
causing deployment of the updated language model to the network device.

13. The system of claim 8, the operations further comprising:
receiving an indication of computing resource constraints of the network device,
wherein the language model is selected based at least in part on it complying with the computing resource constraints of the network device.

14. A method comprising:
receiving device information for a network device deployed in a network that is managed by a network controller;
obtaining a language model that is pre-trained with data associated with at least one of the network or the network device;
augmenting the language model with locally relevant information specific to the network device such that the language model is contextually relevant for the network device; and
causing deployment of the language model to the network device.

15. The method of claim 14, further comprising distilling the language model by:
using the device information, identifying a portion of the language model that is unrelated to functionality of the network device; and
removing the portion of the language model such that the language model requires less memory to store.

16. The method of claim 15, wherein:
the language model is a generic language model that is pre-trained for a plurality of network devices; and
the portion of the language model that is removed from the language model is related to different functionality related to a different network device.

17. The method of claim 15, further comprising:
determining, using the device information, a device type of the network device in the network; and
selecting the language model from a set of language models based at least in part on the language model being pre-trained for the device type.

18. The method of claim 14, further comprising:
using an embedding model, generating embeddings representing the device information, wherein the device information includes locally relevant information specific to the network device;
storing, in a vector database, the embeddings representing the device information; and
configuring the language model to receive the device information from the vector database using retrieval-augmented generation (RAG).

19. The method of claim 14, further comprising:
determining that a new feature has been implemented in the network device;
receiving an updated language model that is pre-trained to answer queries related to the new feature; and
causing deployment of the updated language model to the network device.

20. The method of claim 14, further comprising:
receiving an indication of computing resource constraints of the network device,
wherein the language model is selected based at least in part on it complying with the computing resource constraints of the network device.
